(19) United States
(12) Patent Application Publication
(10) Pub. No.: US 2024/0388072 A1
(43) Pub. Date: Nov. 21, 2024

(54) Channel Routing Entrance and Exits

(71) Applicant: HellermannTyton Corporation, Milwaukee, WI (US)

(72) Inventors: Scott G. Klos, Grafton, WI (US); Mark W. Cors, St. Francis, WI (US)

(21) Appl. No.: 18/667,807

(22) Filed: May 17, 2024

Related U.S. Application Data
(60) Provisional application No. 63/503,018, filed on May 18, 2023.

(51) Int. Cl. H02G 3/04

(52) U.S. Cl. CPC H02G 3/045

(57) ABSTRACT

A channel routing entrance and exit is provided by a channel insert component that enables the passing of one or more elongated objects into or out of a channel. The channel insert component includes an opening configured to receive the one or more elongated objects. The opening is defined by one or more radiused edges that mitigate abrasion of the one or more elongated objects. The channel insert component also includes a notch configured to detachably secure the channel insert component to a protrusion of the channel. The channel insert component also includes a gap along the opening disposed between one or more cantilevers that are flexible from an initial shape to widen the gap, enabling the one or more elongated objects to fit through the gap into the opening.

### INCORPORATION BY REFERENCE

This application claims the benefit under 35 U.S.C. § 119 (e) of U.S. Provisional Application No. 63/503,018, entitled “Channel Routing Entrance/Exits” and filed May 18, 2023, the disclosure of which is incorporated herein by reference in its entirety.

### BACKGROUND

This disclosure generally relates to the field of electrical installations, more specifically to installation of cables, wires, and other elongated objects, and particularly to channel routing assemblies (e.g., cable routing channels, cable management systems, cable duct assemblies, cable ducts, and modular cable duct assemblies). Channel routing assemblies provide a passageway that can be used to conceal, protect, route, secure, and/or organize elongated objects (e.g., wires, cables, etc.) inside open environments, electrical panels, electrical cabinets, conveyors, or other machinery, in hard-to-reach spaces, in confined spaces, and in other applications. Examples of elongated objects include fiber optic cables, electrical cables, power cables, communication cables, conductors, conduits, pipes, hoses, and other wires, cables, or the like.

In certain conventional channel installations, the installer would hand-cut openings (e.g., using a blade, side-cutters, or a saw) into channel cover plates (e.g., covers, channel covers) in order to route elongated objects into or out of the passageway. As they are hand-cut, these openings may be jagged with sharp edges that can damage any elongated objects routed through them (e.g., damage wire coverings/insulation, or the wires themselves, through cutting or abrasion). Further, hand-cutting an opening in a cover can be a time-consuming process and may lead to inconsistent results. Hand-cut openings may also have a ragged look, defeating the clean and refined look desired from the use of channel covers.

### SUMMARY

This document describes channel routing entrances and exits. In aspects, a channel insert component provides channel routing entrances and exits for passing one or more elongated objects into or out of a channel. The channel insert component includes an opening through an anterior face of the channel insert component. The opening is configured to receive the one or more elongated objects. The opening is defined by one or more radiused edges between the anterior face and a posterior face of the channel insert component. The one or more radiused edges are configured to mitigate abrasion of the one or more elongated objects. The channel insert component further includes a notch in the channel insert component. The notch is configured to detachably secure the channel insert component to a protrusion of the channel. The channel insert component has a gap across a lateral face of the channel insert component along the opening. The gap is disposed between one or more cantilevers of the lateral face. The one or more cantilevers are flexible from an initial shape to widen the gap and enable the one or more elongated objects to fit through the gap, into or out of the opening. The one or more cantilevers are resilient to return to the initial shape.

In other aspects, a channel assembly provides for routing of elongated objects. The channel assembly includes a channel and a channel insert component. The channel includes a baseplate integrally connected to a first sidewall and a second sidewall of the channel. A first protrusion of the channel is integrally connected with and perpendicular to the first sidewall. A second protrusion of the channel is integrally connected with and perpendicular to the second sidewall. The baseplate is configured to mount to a piece of machinery.

The channel insert component includes an opening through an anterior face of the channel insert component. The opening is configured to receive one or more elongated objects. The opening is defined by one or more radiused edges between the anterior face and a posterior face of the channel insert component. The one or more radiused edges are configured to mitigate abrasion of the one or more elongated objects during operation of the machinery or during vibration or other movement of the one or more radiused edges against the one or more elongated objects. The channel insert component also includes a first notch and a second notch. The first notch and the second notch in the channel insert component are configured to detachably secure the channel insert component to the channel. The first notch is configured to receive the first protrusion and resist movement of the first protrusion out of the first notch. The second notch is configured to receive the second protrusion and resist movement of the second protrusion out of the second notch. The channel insert component also includes a gap across a lateral face of the channel insert component along the opening. The gap is disposed between one or more cantilevers of the lateral face. The one or more cantilevers are flexible from an initial shape to widen the gap and enable the one or more elongated objects to fit through the gap and into or out of the opening. The one or more cantilevers are resilient to return to the initial shape.

This Summary is provided to introduce simplified concepts of channel routing entrances and exits, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of channel routing entrances and exits are described in this document with reference to the following Drawings, in which the use of the same numbers in different instances may indicate like features and/or components.

FIG. 1 illustrates an anterior perspective view of a channel insert component.

FIG. 2 illustrates a posterior perspective view of the channel insert component.

FIG. 3 illustrates an anterior perspective view of the channel insert component positioned for insertion into a channel.

FIG. 4 illustrates a side elevation view of the channel insert component being flexed as it is inserted into the channel.

FIG. 5 illustrates a side elevation view of the channel insert component secured to the channel.

FIG. 6 illustrates a posterior perspective view of the channel insert component showing a gap through which elongated objects may be received.

FIG. 7 illustrates an anterior perspective view of elongated objects passed through an opening of the channel insert component.

FIG. 8 illustrates an anterior perspective view of the channel insert component and cover plates secured to the channel.

FIG. 9 illustrates a side elevation view of a channel insert component with edge clips secured to a flange channel.

FIG. 10 illustrates an anterior perspective view of a channel insert component having a partially surrounded opening.

FIG. 11 illustrates a posterior perspective view of the channel insert component having the partially surrounded opening.

### DETAILED DESCRIPTION

### Overview

The details of one or more aspects of channel routing entrances/exits are described below. As mentioned above, channel routing assemblies provide a passageway that can be used to conceal, protect, route, secure, and/or organize elongated objects (e.g., wires, cables) inside open environments, electrical panels, electrical cabinets, conveyors, or other machinery, in hard-to-reach spaces, in confined spaces, and in other application. The elongated objects can be fiber optic cables, electrical cables, power cables, communication cables, conductors, conduits, pipes, hoses, and other wires, cables, or the like.

In certain conventional channel installations, the installer would hand-cut openings (e.g., using a blade, side-cutters, or saw) into channel cover plates in order to route elongated objects into or out of the passageway. As they are hand-cut, these openings may be jagged with sharp edges that can damage any elongated objects routed through them (e.g., damage wire coverings/insulation, or the wires themselves, through cutting or abrasion). Further, hand-cutting an opening in a cover can be a time-consuming process and may lead to inconsistent results. Hand-cut openings may also have a ragged look, defeating the clean and refined look desired from the use of channel covers.

Disclosed in this document and the drawings are aspects of channel routing entrances and exits that provide improvements and advantages over conventional hand-cut openings. For instance, the problems of manually cutting a wire exit opening through a cover are solved by adding a channel insert component (e.g., a channel routing entrance and exit). Further, compared to conventional hand-cut openings, the channel insert component described herein provides improved protection against damage (e.g., cutting, abrasion) and quick installation. The channel insert component also provides a clean look that gives the installer/end user an opening from a covered channel. Aspects of the disclosed channel routing entrances and exits may eliminate hand-cut wire exit openings with a simple and consistent approach that saves time. Additionally, the cover may include a gap between the channel insert component defined by straight edge cuts in the cover, which combined with the channel insert component may provide a cleaner look that improves customer satisfaction, while facilitating manufacturing efficiencies. For instance, a channel routing entrance and exit may allow channel covers to be cut at a 90-degree angle, providing a consistent and time-efficient means of adding an opening. The advantages of the disclosed channel insert components are further described below.

### Example Environment

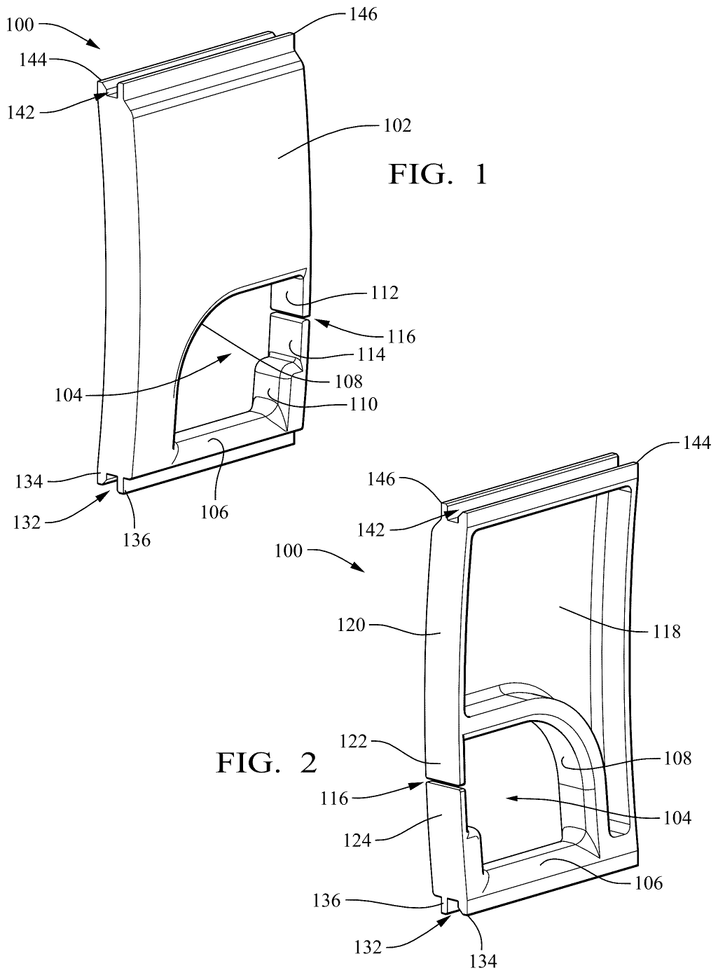

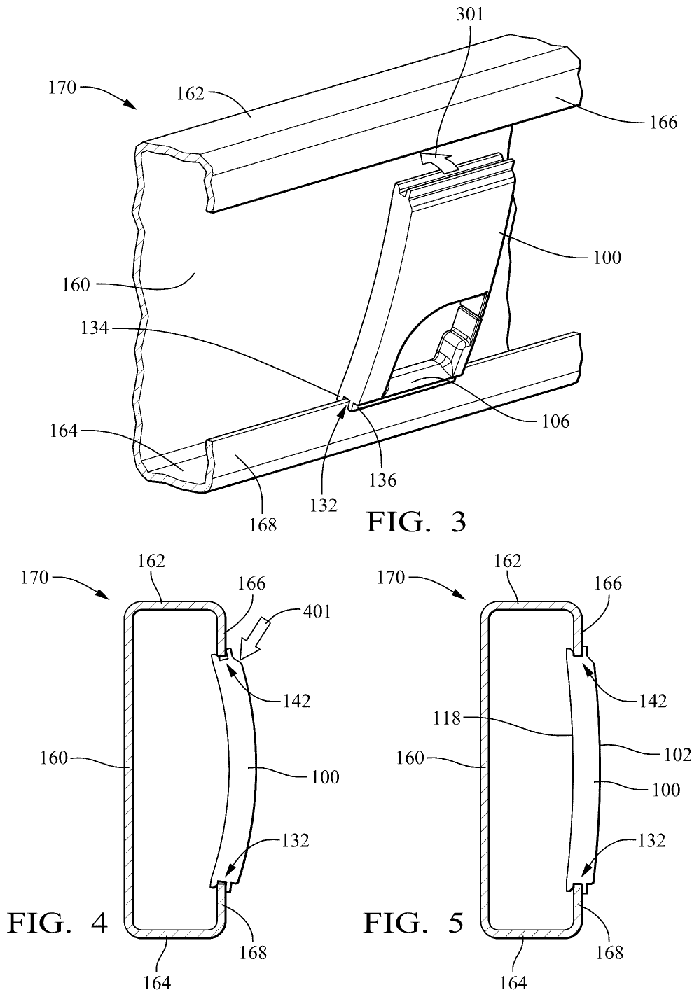

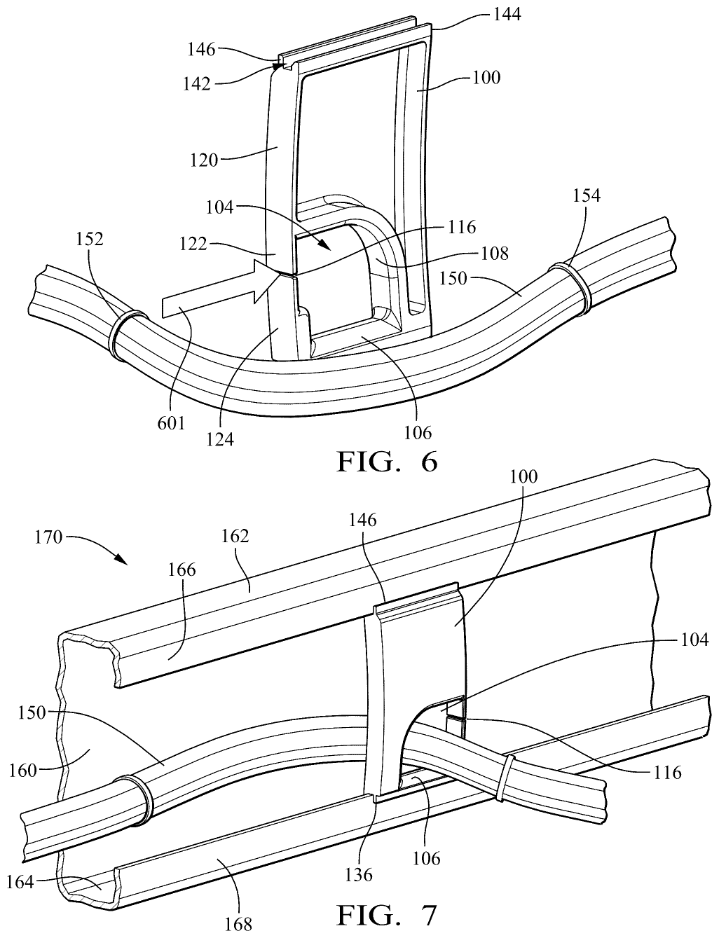

In aspects, a channel insert component 100 provides channel routing entrances and exits for passing one or more elongated objects 150 (see FIGS. 6-8) into or out of a channel 170 (see FIG. 3). The functions and design of the channel insert component 100 are described below with respect to FIG. 1 and FIG. 2. Insertion of the channel insert component 100 into the channel 170 is described below with respect to FIGS. 3-5. Routing of elongated objects 150 through an opening 104 of the channel insert component 100 is described below with respect to FIGS. 6-8. The same reference numbers are used in different figures to indicate the same elements.

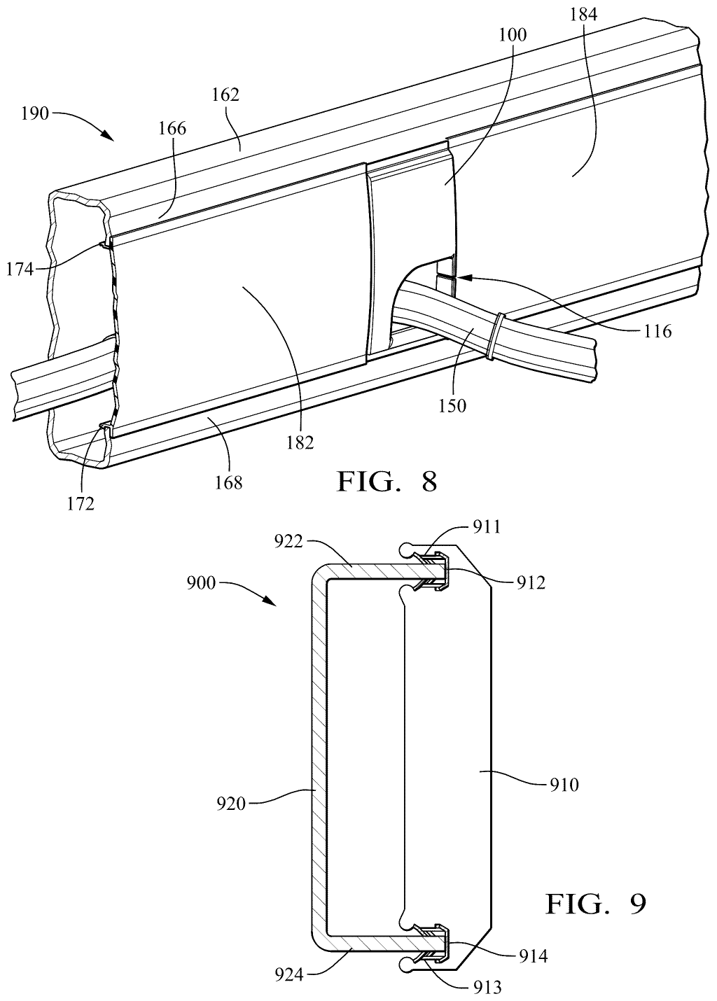

FIG. 1 illustrates an anterior perspective view of the channel insert component 100. The channel insert component 100 includes the opening 104 through an anterior face 102 of the channel insert component 100. Advantageously, the anterior face 102 and opening 104 of the channel insert component 100 provide a clean, refined, and consistent look compared to hand-cut openings (also see FIG. 8 and its corresponding description below).

The opening 104 is configured to receive the one or more elongated objects 150 (see FIGS. 6-8). For example, elongated objects 150 routed through the channel 170 may be passed through the opening 104 to exit the channel 170. As another example, elongated objects 150 may be passed into the channel 170. FIGS. 6-8 (described below) show an example implementation where the one or more elongated objects 150 are a bundle of wires that exit the channel 170 through the opening 104 of the channel insert component 100.

The opening 104 may be defined by one or more radiused edges (e.g., radiused edge 106, radiused edge 108, radiused edge 110) between the anterior face 102 and a posterior face 118 (see FIG. 2) of the channel insert component 100. Advantageously, the one or more radiused edges (e.g., radiused edge 106, radiused edge 108, radiused edge 110) are configured to mitigate abrasion of the one or more elongated objects 150. For example, the one or more radiused edges (e.g., radiused edge 106, radiused edge 108, radiused edge 110) may cause less abrasion of the elongated objects 150 compared to sharp or jagged edges (e.g., on a hand-cut opening). That is, rounded surfaces of the one or more radiused edges (e.g., radiused edge 106, radiused edge 108, radiused edge 110) may not dig into or cut against the elongated objects 150 like how sharp or jagged edges may, even during vibration, pulling, sliding, or other physical motion of the elongated objects 150 across the surfaces of the one or more radiused edges (e.g., radiused edge 106, radiused edge 108, radiused edge 110). Accordingly, the one or more radiused edges (e.g., radiused edge 106, radiused edge 108, radiused edge 110) are configured to mitigate abrasion of the one or more elongated objects 150 during operation of machinery or during vibration or other movement of the one or more radiused edges (e.g., radiused edge 106, radiused edge 108, radiused edge 110) against the one or more elongated objects 150.

Furthermore, the opening 104 may be a closed-ended breech, as opposed to an open-ended breech, meaning that the opening 104 is surrounded on all sides (except for a gap 116 and the opening 104 itself) by the material of the channel insert component 100 rather than being open at one end or side. As such, the channel insert component 100 separates and protects the elongated objects 150 from touching the channel 170 or protrusions (e.g., protrusion 166, protrusion 168) of the channel 170 (shown in FIG. 3) that may have sharp edges or may be made from a harder material compared to the elongated objects 150, such as metal or hard plastic.

In aspects, the channel insert component 100 is composed of a thermoplastic elastomer material. The elastomeric properties of such materials may mitigate abrasion, as such materials may be soft and pliable. Making the channel insert component 100 using a thermoplastic elastomer material also means that it can be bent and inserted into the channel 170 (see the description of FIGS. 3-5 below) and that it is soft to the touch (e.g., compared to harder plastic materials having a higher durometer).

In aspects, the channel insert component 100 is composed of a material having a durometer providing mitigation of abrasion of the one or more elongated objects 150. For example, the durometer of the material (a measure indicating hardness) of the channel insert component 100 may be within a range of 55 to 65. A softer-durometer (lower durometer value) material may mitigate abrasion of the elongated objects 150 as coverings or insulation of the elongated objects 150 may be harder (higher durometer value) than the channel insert component 100.

In aspects, widths of the one or more radiused edges (e.g., radiused edge 106, radiused edge 108, radiused edge 110) of the channel insert component 100 are wider than a first protrusion 168 of the channel 170 (see FIG. 3). For example, the one or more radiused edges (e.g., radiused edge 106, radiused edge 108, radiused edge 110) of the channel insert component 100 may have a radius of at least one-eighth of an inch. In other aspects, the radius of the one or more radiused edges (e.g., radiused edge 106, radiused edge 108, radiused edge 110) may be a different size or it may be set or scaled based on a diameter or width of the elongated objects 150, for example.

Advantageously, the rounded features and softness of the material of the channel insert component 100 provide improved mitigation against abrasion of the elongated objects 150 compared to prior channel openings such as jagged hand-cut openings. Mitigation of abrasion against the one or more elongated objects 150 is further described below.

The channel insert component 100 also has a gap 116 across a lateral face 120 (see FIG. 2) of the channel insert component 100 along the opening 104. The gap 116 may be disposed between one or more cantilevers (e.g., cantilever 122, cantilever 124) of the lateral face 120. The one or more cantilevers (e.g., cantilever 122, cantilever 124) are flexible from an initial shape to widen the gap 116 and enable the one or more elongated objects 150 to fit through the gap 116, into or out of the opening 104. The one or more cantilevers (e.g., cantilever 122, cantilever 124) are flexible but resilient to return to their initial shape. Further, the one or more cantilevers (e.g., cantilever 122, cantilever 124) have flat surfaces facing the opening 104, providing flexibility while mitigating abrasion of the elongated objects 150. Advantageously, the gap 116 can be used to position the elongated objects 150 into the opening 104 without having to thread an end of each elongated object 150 through the opening 104 and then pull the remaining length of the elongated object 150 through the opening 104. Positioning of the elongated objects 150 in the opening 104 through the gap 116 is further described below with respect to FIG. 6 and FIG. 7.

The channel insert component 100 may be configured to be detachably secured to the channel 170 using notches (e.g., first notch 132, second notch 142). The channel insert component 100 includes a first notch 132. The first notch 132 may be defined by and located between a first posterior ridge 134 and a first anterior ridge 136. The first anterior ridge 136 may be a flat rectangular protrusion, as shown in FIG. 1 and FIG. 2. The first notch 132 may be configured to detachably secure the channel insert component 100 to the first protrusion 168 (see FIG. 3) of the channel 170. The first posterior ridge 134 may have an angled portion facing the first notch 132 such that the channel insert component 100 can be removed from the channel 170 by pushing the channel insert component 100 towards the outside of the channel 170 from inside of the channel 170.

The channel insert component 100 further includes a second notch 142. The second notch 142 may be defined by and located between a second posterior ridge 144 and a second anterior ridge 146. The second anterior ridge 146 may be a flat rectangular protrusion, as shown in FIG. 1 and FIG. 2. The second notch 142 may be configured to detachably secure the channel insert component 100 to a second protrusion 166 of the channel 170. The second posterior ridge 144 may have an angled portion facing the second notch 142 such that the channel insert component 100 can be removed from the channel 170 by pushing the channel insert component 100 towards the outside of the channel 170 from inside of the channel 170.

Inserting and securing the channel insert component 100 into the channel 170 by setting the first protrusion 168 and second protrusion 166 of the channel 170 into the first and second notches (e.g., first notch 132, second notch 142) is further described below with respect to FIGS. 3-5.

FIG. 2 illustrates a posterior perspective view of the channel insert component 100. As shown in FIG. 2, the one or more cantilevers (e.g., cantilever 122, cantilever 124) may also have flat surfaces facing out from the lateral face 120. As such, the one or more cantilevers (e.g., cantilever 122, cantilever 124) are flexible and can be pushed inward towards the opening 104 when fitting the elongated objects 150 through the gap 116. FIG. 2 also shows the posterior face 118 of the channel insert component 100 and the structure of the material of the channel insert component 100 forming the radiused edge 108 between the anterior face 102 and the posterior face 118. The structure of the channel insert component 100 may be configured to provide rigidity to keep it secured to the channel 170 while being flexible enough to be bent into place during insertion into the channel 170.

Insertion of the channel insert component 100 into the channel 170 is now described with respect to FIGS. 3-5.

FIG. 3 illustrates an anterior perspective view of the channel insert component 100 positioned for insertion into the channel 170. Some channels or channel assemblies include a baseplate configured for mounting to a surface and a pair of spaced apart and opposing sidewalls extending from the baseplate and defining a passageway therein. For example, a baseplate may be mounted to a wall or to machinery such as a conveyor. In aspects, the baseplate and opposing sidewalls may be formed together (e.g., extruded) as a channel. In aspects, a channel may have a “U-shaped” cross section, a “C-shaped” cross section, or another-shaped cross section.

In the example shown in FIG. 3, the channel 170 includes a baseplate 160. The baseplate 160 may be configured to be mounted to a surface or a piece of machinery (e.g., using screws, bolts, slots, adhesion, etc.). The baseplate 160 may be integrally connected to a first sidewall 164 and a second sidewall 162 of the channel 170.

In this example, the channel 170 is a raceway-type channel having protrusions perpendicular to sidewalls. As shown in FIG. 3, the sidewalls (e.g., second sidewall 162, first sidewall 164) (e.g., the ends of the sidewalls) may include inwardly extending first and second protrusions or flanges that extend perpendicularly away from the sidewalls. For instance, in FIG. 3 the first protrusion 168 of the channel 170 is integrally connected with and perpendicular to the first sidewall 164 and the second protrusion 166 of the channel is integrally connected with and perpendicular to the second sidewall 162. The protrusions or flanges may be configured for mating with a cover (e.g., cover plate). For instance, a cover plate may be able to snap onto the channel 170. This is further described below with respect to FIG. 8.

As mentioned above, the channel insert component 100 in FIG. 3 is positioned for insertion into the channel 170. The following is a technique for inserting the channel insert component 100 into the channel 170. Other techniques may be utilized to perform insertion as well.

In aspects, to insert the channel insert component 100 into the channel 170, either the first notch 132 or the second notch 142 may be aligned with the first protrusion 168 or the second protrusion 166, respectively. In the example shown in FIG. 3, the first notch 132 of the channel insert component has been aligned with the first protrusion 168 of the channel 170. Then, the respective protrusion may be received or positioned within the corresponding notch. In the example shown in FIG. 3, the first protrusion has already been received into the first notch 132 such that it is positioned between the first anterior ridge 136 and the first posterior ridge 134.

After the first protrusion 168 is received into the first notch 132, force may be applied to the channel insert component 100, as shown by an arrow 301 in FIG. 3, such that the channel insert component 100 is rotated about the first protrusion 168 towards the channel 170. Accordingly, the second notch 142 moves towards the second protrusion 166. Then the channel insert component 100 can be bent into place, as described below.

Another option would be to position the second protrusion 166 of the channel 170 in the second notch 142 and then rotate the channel insert component 100 towards the first protrusion 168.

The height of the channel insert component 100 (from the end of the first anterior ridge 136 to the end of the second anterior ridge 146) may be longer than the distance between the ends of the first protrusion 168 and the second protrusion 166 (see FIG. 5), which ensures that the channel insert component 100 is secure once inserted into the channel 170. The channel insert component 100 can be bent in order to fit it between the first protrusion 168 and the second protrusion 166 of the channel 170, thereby securing the channel insert component 100 into the channel 170. This technique is further described below with respect to FIG. 4 and FIG. 5.

FIG. 4 illustrates a side elevation view of the channel insert component 100 being flexed as it is inserted into the channel 170. As mentioned above, the channel insert component 100 may be made of a thermoelastic polymer material such that it is both pliable and resilient. In this example, the channel insert component 100 is forced down, as indicated by an arrow 401, towards the first protrusion 168 such that the channel insert component 100 bends outwards (away from the channel 170). The bending enables the second notch 142 to become aligned with the second protrusion 166 such that the second protrusion 166 can be received within the second notch 142, as shown in FIG. 4. The force of pressing down on the channel insert component 100 may also cause the first protrusion 168 or the first sidewall 164 of the channel 170 to bend, enabling the channel insert component 100 to fit.

When both the first protrusion 168 and the second protrusion 166 are received into their corresponding notches (e.g., first notch 132, second notch 142), the force applied to the channel insert component 100 may be removed, causing the channel insert component 100 to return to its original (unbent) shape. Thus, the channel insert component 100 can securely snap into place in the channel 170.

FIG. 5 illustrates a side elevation view of the channel insert component 100 secured to the channel 170. In aspects, the channel insert component 100 may be further secured by compression from the first protrusion 168 and second protrusion 166. In aspects, the channel insert component 100 may be able to slide along the channel 170 to be positioned after being inserted.

As mentioned above, the first anterior ridge 136 and the second anterior ridge 146 may both be flat rectangular protrusions. As such, the channel insert component 100 may be secured against the channel 170 and the channel insert component 100 may resist inward force pressing from outside the channel 170. However, the channel insert component 100 may be detachably secured and may be removed from the channel 170 by outward force pressing from inside the channel 170. As mentioned above, the first posterior ridge 134 may have an angled portion facing the first notch 132 and the second posterior ridge 144 may have an angled portion facing the second notch 142. As such, the channel insert component 100 can be removed from the channel 170 by pushing the channel insert component 100 towards the outside of the channel 170 from inside of the channel 170. Advantageously, the channel insert component 100 may require comparatively less force to remove when pushing from the inside (as when removing the cover plates or otherwise disassembling the channel assembly) and may require comparatively more force to become dislodged or detached from the channel 170 when pushing from the outside (which may be done accidentally).

In other aspects, the first posterior ridge 134 and the second posterior ridge 144 may have angled portions facing away from the first notch 132 and the second notch 142, respectively, such that the channel insert component 100 can be inserted into the channel 170 by pushing the channel insert component 100 towards the inside of the channel 170. In such aspects the channel insert component 100 may require comparatively less force to insert when pushing from the outside. In some aspects the durometer of the material of the channel insert component 100 may be selected to provide the channel insert component 100 with flexibility to be inserted into the channel 170 given a predetermined amount of insertion force.

In other different aspects or implementations, the channel 170 may be a flange channel or C-channel with sidewalls but without protrusions. In such aspects, the notches of the channel insert component 100 can include one or more edge clips configured to retain a portion of the sidewall in the notch. The edge clips may be self-affixing edge clips that affix to the channel sidewalls. Such aspects are further described below with respect to FIG. 9.

Routing of elongated objects 150 through the opening 104 of the channel insert component 100 is described below with respect to FIGS. 6-8.

FIG. 6 illustrates a posterior perspective view of the channel insert component 100 showing a gap 116 through which elongated objects 150 may be received. As mentioned above, the channel insert component 100 has a gap 116 across a lateral face 120 of the channel insert component 100 along the opening 104. The gap 116 may be disposed between one or more cantilevers (e.g., cantilever 122, cantilever 124) of the lateral face 120.

As shown in the example of FIG. 6, the one or more elongated objects 150 can be a bundle of wires or cables secured together using cable ties (e.g., cable tie 152, cable tie 154) or other strapping material (e.g., plastic bands, flexible bands, metal bands, strings, twine, wires). The one or more elongated objects 150 may be routed through the channel 170 as shown in FIG. 7 and described below. In some channel installations, it is needed or desired to have the elongated objects 150 enter or exit the channel 170. The opening 104 of the channel insert component 100 can be used to pass the elongated objects 150 out of the channel 170.

To get the one or more elongated objects 150 into the opening 104, they can be forced though the gap 116 between the one or more cantilevers (e.g., cantilever 122, cantilever 124) as shown by an arrow 601 in FIG. 6. The one or more cantilevers are flexible from an initial shape to widen the gap 116 and enable the one or more elongated objects 150 to fit through the gap 116 into the opening 104. The one or more cantilevers (e.g., cantilever 122, cantilever 124) are also resilient and can return to their initial shape. The one or more elongated objects 150 can be removed from the opening 104 back through the gap 116 in a reverse fashion.

Advantageously, the gap 116 can be used to position the one or more elongated objects 150 into the opening 104 without having to thread the end of each elongated object 150 through the opening 104 and pull the remaining length through the opening 104.

FIG. 7 illustrates an anterior perspective view of elongated objects 150 passed through the opening 104 of the channel insert component 100. The channel insert component 100 may be inserted into channel 170 as described above with respect to FIGS. 3-5. The one or more elongated objects 150 can be routed through the opening 104 of the channel insert component 100 either before or after the channel insert component 100 is secured to the channel 170.

As mentioned above, the channel 170 may be made of a harder material compared to the one or more elongated objects 150 and may cause abrasion or other damage as previously mentioned. As one example, the channel 170 may be made of metal and the elongated objects 150 may have a flexible polyvinyl chloride (PVC) covering. To protect the one or more elongated objects 150 against abrasion or other damage from the channel 170, the radiused edge 106 separates the one or more elongated objects 150 from the first protrusion 168 of the channel 170, as shown in FIG. 7. In addition, the first anterior ridge 136 also protects the one or more elongated objects 150 by spacing the one or more elongated objects 150 apart from an edge of the first protrusion 168 of the channel 170.

FIG. 8 illustrates an anterior perspective view of the channel insert component 100 and cover plates (e.g., cover plate 182, cover plate 184) secured to the channel 170. In this example, the first cover plate 182 and a second cover plate 184 are secured to the channel 170 alongside the channel insert component 100. The cover plates (e.g., cover plate 182, cover plate 184) and the channel 170 may be made from a plastic material and/or a metal material, for example. The cover plates (e.g., cover plate 182, cover plate 184) are both detachably secured to the first protrusion 168 and the second protrusion 166 of the channel 170. To do this, the cover plates can include detents configured to receive and snap onto the protrusions 166, 168 of the channel 170. As shown in FIG. 8, the first cover plate 182 has a first detent 172 configured to snap onto the first protrusion 168. The first cover plate 182 also has a second detect 174 to snap onto the second protrusion 166. The cover plates (e.g., cover plate 182, cover plate 184) enclose the passageway of the channel 170 and give the channel assembly a clean and refined look. In aspects, the cover plates (e.g., cover plate 182, cover plate 184) can be opened to access the contents (e.g., elongated objects 150) of the channel 170 passageway and can be closed to keep the contents out of sight.

FIG. 9 illustrates a side elevation view of a channel insert component 910 with edge clips (e.g., edge clip 912, edge clip 914) secured to a flange channel 900. The flange channel 900 (also known as a “C-channel”) includes a baseplate 920 integrally connected to a first sidewall 924 and a second sidewall 922. The flange channel 900 is different from the “raceway” style channel described above. For instance, the flange channel 900 does not include inwardly extending first and second protrusions that extend perpendicularly away from the sidewalls.

Given this configuration of the flange channel 900, the channel insert component 910 may include one or more notches (e.g., notch 911, notch 913) which house one or more edge clips (e.g., edge clip 912, edge clip 914) that are configured to retain portions of the sidewalls in the notches. As shown in FIG. 9, the lower notch 913 of the channel insert component 910 is secured to the first sidewall 924 by the lower edge clip 914. Further, the upper notch 911 of the channel insert component 910 is secured to the second sidewall 922 by the upper edge clip 912. In aspects, the edge clips 912, 914 may be made of metal. In aspects, the edge clips 912, 914 may be self-affixing edge clips that are secured to the channel sidewalls (e.g., by friction). For example by pushing the channel insert 910 onto the sidewalls 922, 924 of the channel 900.

FIG. 10 illustrates an anterior perspective view of a channel insert component 1000 having a partially surrounded opening 1004. The channel insert component 1000 includes the opening 1004 through an anterior face 1002 of the channel insert component 1000. Advantageously, the anterior face 1002 and opening 1004 of the channel insert component 1000 provide a clean, refined, and consistent look compared to hand-cut openings.

The opening 1004 is configured to receive the one or more elongated objects (as discussed above). For example, elongated objects routed through a channel may be passed through the opening 1004 to exit the channel. As another example, elongated objects may be passed into the channel 170 (e.g., as illustrated in FIGS. 1, 7, and 8).

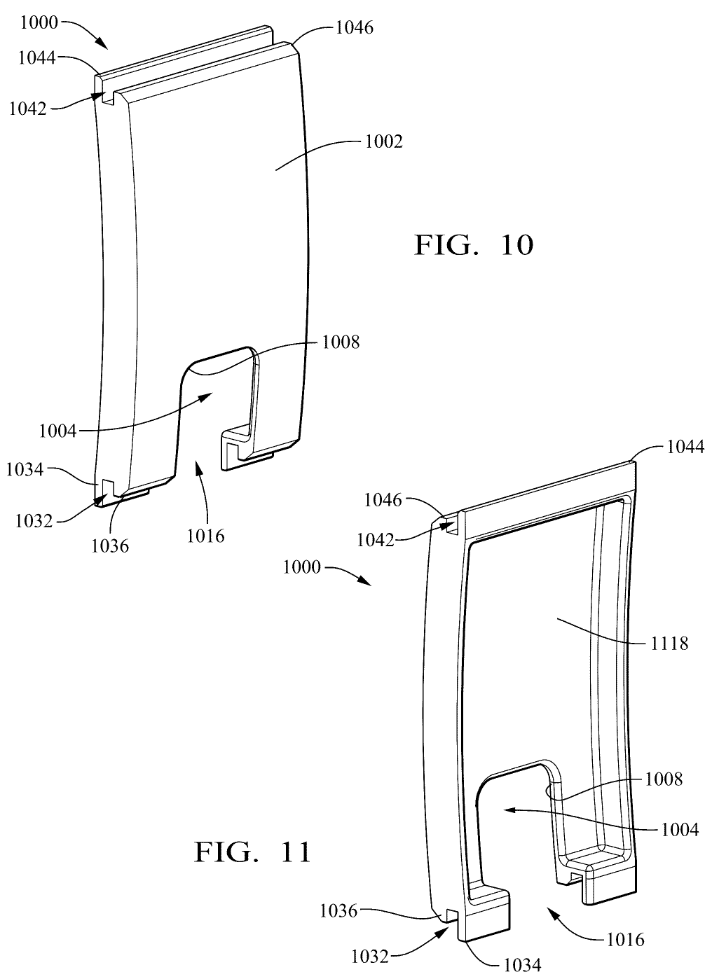

The opening 1004 may be defined by one or more radiused edges (e.g., radiused edge 1008) between the anterior face 1002 and a posterior face 1118 (see FIG. 11) of the channel insert component 1000. Advantageously, the one or more radiused edges are configured to mitigate abrasion of the one or more elongated objects routed through the opening 1004. For example, the one or more radiused edges (e.g., radiused edge 1008) may cause less abrasion of the elongated objects compared to sharp or jagged edges (e.g., on a hand-cut opening). That is, rounded surfaces of the one or more radiused edges (e.g., radiused edge 1008) may not dig into or cut against the elongated objects like how sharp or jagged edges may, even during vibration, pulling, sliding, or other physical motion of the elongated objects across the surfaces of the one or more radiused edges (e.g., radiused edge 1008). Accordingly, the one or more radiused edges (e.g., radiused edge 1008) are configured to mitigate abrasion of the one or more elongated objects during operation of machinery or during vibration or other movement of the one or more radiused edges (e.g., radiused edge 1008) against the one or more elongated objects.

Furthermore, the opening 1004 may be an open-ended breech, as opposed to the closed-ended breech described above. An open-ended breech meaning that the opening 1004 is partially surrounded. As shown in FIG. 11, the opening 1004 is open at 1016 towards where the notch 1032 would receive the channel protrusion once inserted. As such, the channel insert component 1000 separates and protects the elongated objects from touching the channel or protrusions of the channel except along opening 1016. However, the channel insert component 1000 may be oriented up or down (or left or right depending on channel orientation) within the channel such that the elongated objects are protected from leaning against or touching the channel or channel protrusions. Advantageously, the channel insert component 1000 may be simpler to manufacture (e.g., compared to the channel insert component 100) while providing a similar level of protection depending on the particular installation environment.

The channel insert component 1000 may be configured to be detachably secured to the channel using notches (e.g., notch 1032, notch 1042). The channel insert component 1000 includes a first notch 1032. The first notch 1032 may be defined by and located between a first posterior ridge 1034 and a first anterior ridge 1036. The first anterior ridge 1036 may have an angled portion facing away from the first notch 1032 such that the channel insert component 1000 can be inserted into the channel by pushing the channel insert component 1000 inwards towards the inside of the channel from outside of the channel. The first posterior ridge 1034 may be a flat rectangular protrusion, as shown in FIG. 10 and FIG. 11. The first notch 1032 may be configured to detachably secure the channel insert component 1000 to a first protrusion a raceway style channel (e.g., to the first protrusion of the 168 of the channel 170 in FIG. 3).

The channel insert component 1000 further includes a second notch 1042. The second notch 1042 may be defined by and located between a second posterior ridge 1044 and a second anterior ridge 1046. The second anterior ridge 1046 may have an angled portion facing away the second notch 1042 such that the channel insert component 1000 can be inserted into the channel by pushing the channel insert component 1000 towards the inside of the channel from outside of the channel. The second posterior ridge 1044 may be a flat rectangular protrusion, as shown in FIG. 10 and FIG. 11. The second notch 1042 may be configured to detachably secure the channel insert component 1000 to a second protrusion of the channel.

In aspects, the channel insert component 1000 is composed of a thermoplastic elastomer material. The elastomeric properties of such materials may mitigate abrasion, as such materials may be soft and pliable. Making the channel insert component 1000 using a thermoplastic elastomer material also means that it can be bent and inserted into the channel and that it is soft to the touch. In aspects, the channel insert component 1000 is composed of a material having a durometer providing mitigation of abrasion of the one or more elongated objects. For example, the durometer of the material (a measure indicating hardness) of the channel insert component 1000 may be within a range of 55 to 65. A softer-durometer (lower durometer value) material may mitigate abrasion of the elongated objects as coverings or insulation of the elongated objects may be harder (higher durometer value) than the channel insert component 1000. In other aspects, the channel insert component (e.g., channel insert component 100, channel insert component 1000) may be composed of a harder and less flexible material (e.g., higher durometer) such that it snaps into place when inserted into the channel (e.g., by flexing the channel to a greater degree), rather than being bent itself.

FIG. 11 illustrates a posterior perspective view of the channel insert component 1000 having the partially surrounded opening. FIG. 11 shows the posterior face 1118 of the channel insert component 1000 and the structure of the material of the channel insert component 1000 forming the radiused edge 1008 between the anterior face 1002 and the posterior face 1118. The problems of manually cutting a wire exit opening through a channel cover were previously described. These problems are solved by adding a channel insert component 1000 that mitigates abrasion and other damage while providing a clean-looking wire entrance and exit. Furthermore, the dimensions and straight sides of the channel insert component 1000 allow the channel covers to be cut at a 90-degree angle, providing a consistent and time-efficient means of adding channel entrances/exits. The channel insert component described herein is especially advantageous in channel assembly installations that undergo vibration (which can cause abrasion over time) such as installations on machinery (e.g., conveyors) or in vehicles (e.g., rail cars).

### Materials

The components of the disclosed channel routing entrances and exits may be fabricated of any suitable material, including, but not limited to, a metal, a ceramic, a polymer (e.g., a polymeric material), and/or a composite. Suitable polymeric materials may include one or more of polyamide (PA), polypropylene (PP), polyethylene (PE), polyphenylene sulfide (PPS), polyether ether ketone (PEEK), polyaryletherketone (PAEK), ethylene tetrafluoroethylene (ETFE), polyacetal (POM), polybutylene terephthalate (PBT), ultraviolet stabilized polyacetal (POMUV), acrylonitrile styrene acrylate (ASA), cross-linked thermoplastics, partially cross-linked thermoplastics, higher-temperature resins, thermoplastic elastomer materials, ultraviolet (UV) resistant resins, other thermoplastic materials, and the like, and copolymers, blends, or alloys thereof, as well as fiber reinforced materials. A suitable polymeric material may include one or more additives (e.g., heat stabilizers (e.g., copper iodide), impact modifiers (e.g., polyolefin, urethane, rubber), UV stabilizers (e.g., carbon black, hindered amine light stabilizers (HALS)), flame retardants (e.g., nitrogen-based halogen-free flame retardants, melamine cyanurate, melamine borate, ammonium polyphosphate), colorants, and the like).

### Additional Examples

Some additional examples of channel routing entrances and exits are as follows:

Example 1. A channel insert component for passing one or more elongated objects into or out of a channel. The channel insert component comprises an opening through an anterior face of the channel insert component. The opening is configured to receive the one or more elongated objects. The opening is defined by one or more radiused edges between the anterior face and a posterior face of the channel insert component. The one or more radiused edges are configured to mitigate abrasion of the one or more elongated objects. The channel insert component also comprises a notch in the channel insert component configured to detachably secure the channel insert component to a protrusion of the channel. The channel insert component also comprises a gap across a lateral face of the channel insert component along the opening. The gap is disposed between one or more cantilevers of the lateral face. The one or more cantilevers are flexible from an initial shape to widen the gap and enable the one or more elongated objects to fit through the gap and into or out of the opening. The one or more cantilevers are resilient to return to the initial shape.

Example 2. The channel insert component of Example 1, wherein the protrusion of the channel is integrally connected with and perpendicular to a sidewall of the channel, the sidewall integrally connected to a baseplate of the channel, and wherein the notch is defined by an anterior ridge and a posterior ridge, the anterior ridge spacing the one or more elongated objects apart from an edge of the protrusion of the channel.

Example 3. The channel insert component of Example 2, wherein the posterior ridge includes an angled portion facing the notch such that the channel insert component can be removed from the channel by pushing the channel insert component towards the outside of the channel from inside of the channel.

Example 4. The channel insert component of Example 2, wherein the anterior ridge is a flat rectangular protrusion.

Example 5. The channel insert component of Example 1, wherein the protrusion of the channel is a sidewall of the channel that is integrally connected to a baseplate of the channel, and wherein the notch of the channel insert component includes one or more edge clips configured to retain a portion of the sidewall in the notch.

Example 6. The channel insert component of Example 1, wherein the channel insert component is composed of a thermoplastic elastomer material.

Example 7. The channel insert component of Example 1, wherein the channel insert component is composed of a material having a durometer providing mitigation of abrasion of the one or more elongated objects.

Example 8. The channel insert component of Example 7, wherein the durometer of the material of the channel insert component is within a range of 55 to 65.

Example 9. The channel insert component of Example 1, wherein a width of the one or more radiused edges of the channel insert component is wider than the protrusion of the channel.

Example 10. The channel insert component of Example 1, wherein the one or more radiused edges of the channel insert component have a radius of at least one eighth of an inch.

Example 11. The channel insert component of Example 1, wherein the notch is a first notch, the protrusion of the channel is a first protrusion, and the channel insert component further comprises a second notch configured to detachably secure the channel insert component to a second protrusion of the channel.

Example 12. The channel insert component of Example 1, wherein a posterior side of the channel insert component has a structure configured to increase rigidity of the channel insert component.

Example 13. The channel insert component of Example 1, wherein the channel is a raceway-type channel and the protrusion of the channel is perpendicular to a sidewall of the channel.

Example 14. The channel insert component of Example 1, wherein the opening of the channel insert component is open-ended towards the protrusion of the channel.

Example 15. A channel assembly for routing elongated objects. The channel assembly comprising a channel including a baseplate integrally connected to a first sidewall and a second sidewall of the channel. A first protrusion of the channel is integrally connected with and perpendicular to the first sidewall. A second protrusion of the channel is integrally connected with and perpendicular to the second sidewall. The baseplate configured to mount to a piece of machinery. The channel assembly also comprises a channel insert component. The channel insert component comprises an opening through an anterior face of the channel insert component configured to receive one or more elongated objects. The opening is defined by one or more radiused edges between the anterior face and a posterior face of the channel insert component. The one or more radiused edges are configured to mitigate abrasion of the one or more elongated objects during operation of the machinery or during vibration or other movement of the one or more radiused edges against the one or more elongated objects. The channel insert component also comprises a first notch and a second notch in the channel insert component configured to detachably secure the channel insert component to the channel. The first notch is configured to receive the first protrusion and resist movement of the first protrusion out of the first notch. The second notch configured to receive the second protrusion and resist movement of the second protrusion out of the second notch. The channel insert component also comprises a gap across a lateral face of the channel insert component along the opening. The gap is disposed between one or more cantilevers of the lateral face. The one or more cantilevers being flexible from an initial shape to widen the gap and enable the one or more elongated objects to fit through the gap and into or out of the opening. The one or more cantilevers are resilient to return to the initial shape.

Example 16. The channel assembly of Example 15, wherein the first notch is defined by a first anterior ridge and a first posterior ridge, the first anterior ridge spacing the one or more elongated objects apart from an edge of the first protrusion of the channel, and wherein the first posterior ridge includes an angled portion facing the first notch such that the channel insert component can be removed from the channel by pushing the channel insert component towards the outside of the channel from inside of the channel.

Example 17. The channel assembly of Example 15, wherein the channel insert component is composed of a material having a durometer providing mitigation of abrasion of the one or more elongated objects.

Example 18. The channel assembly of Example 15, wherein a width of the one or more radiused edges of the channel insert component is wider than the protrusion of the channel.

Example 19. The channel assembly of Example 15, wherein the one or more cantilevers of the lateral face have a flat surface facing the opening.

Example 20. The channel assembly of Example 15, further comprising a channel cover plate detachably secured to the first protrusion and the second protrusion of the channel, wherein the channel cover plate includes a detent configured to receive the first protrusion of the channel.

In aspects, a channel routing entrance and exit may include one or more of the features of the channel routing entrances and exits illustrated in the drawings and described above.

### Construction

As used herein, the following terms have the following meanings, unless the context clearly dictates otherwise. The term “flexible” refers to an object or material that is able to be bent, stretched, or compressed without cracking or breaking. The term “resilient” is used to qualify a flexible feature as generally returning to an initial general shape without permanent deformation after bending, stretching, and/or being compressed.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although implementations for channel routing entrances/exits have been described in language specific to certain features and/or methods, the subject of the appended claims is not necessarily limited to the specific features or methods described. Rather, the specific features and methods are disclosed as example implementations for channel routing entrances/exits.

What is claimed is:

1. A channel insert component for passing one or more elongated objects into or out of a channel, the channel insert component comprising:
an opening through an anterior face of the channel insert component, the opening configured to receive the one or more elongated objects, the opening defined by one or more radiused edges between the anterior face and a posterior face of the channel insert component, the one or more radiused edges configured to mitigate abrasion of the one or more elongated objects;
a notch in the channel insert component configured to detachably secure the channel insert component to a protrusion of the channel; and
a gap across a lateral face of the channel insert component along the opening, the gap disposed between one or more cantilevers of the lateral face, the one or more cantilevers being flexible from an initial shape to widen the gap and enable the one or more elongated objects to fit through the gap and into or out of the opening, the one or more cantilevers being resilient to return to the initial shape.

2. The channel insert component of claim 1, wherein the protrusion of the channel is integrally connected with and perpendicular to a sidewall of the channel, the sidewall integrally connected to a baseplate of the channel, and wherein the notch is defined by an anterior ridge and a posterior ridge, the anterior ridge spacing the one or more elongated objects apart from an edge of the protrusion of the channel.

3. The channel insert component of claim 2, wherein the posterior ridge includes an angled portion facing the notch such that the channel insert component can be removed from the channel by pushing the channel insert component towards an outside of the channel from inside of the channel.

4. The channel insert component of claim 2, wherein the anterior ridge is a flat rectangular protrusion.

5. The channel insert component of claim 1, wherein the protrusion of the channel is a sidewall of the channel that is integrally connected to a baseplate of the channel, and wherein the notch of the channel insert component includes one or more edge clips configured to retain a portion of the sidewall in the notch.

6. The channel insert component of claim 1, wherein the channel insert component is composed of a thermoplastic elastomer material.

7. The channel insert component of claim 1, wherein the channel insert component is composed of a material having a durometer providing mitigation of abrasion of the one or more elongated objects.

8. The channel insert component of claim 7, wherein the durometer of the material of the channel insert component is within a range of 55 to 65.

9. The channel insert component of claim 1, wherein a width of the one or more radiused edges of the channel insert component is wider than the protrusion of the channel.

10. The channel insert component of claim 1, wherein the one or more radiused edges of the channel insert component have a radius of at least one-eighth of an inch.

11. The channel insert component of claim 1, wherein the notch is a first notch, the protrusion of the channel is a first protrusion, and the channel insert component further comprises a second notch configured to detachably secure the channel insert component to a second protrusion of the channel.

12. The channel insert component of claim 1, wherein a posterior side of the channel insert component has a structure configured to increase rigidity of the channel insert component.

13. The channel insert component of claim 1, wherein the channel is a raceway-type channel and the protrusion of the channel is perpendicular to a sidewall of the channel.

14. The channel insert component of claim 1, wherein the opening of the channel insert component is open-ended towards the protrusion of the channel.

15. A channel assembly for routing elongated objects, comprising:
a channel including a baseplate integrally connected to a first sidewall and a second sidewall of the channel, a first protrusion of the channel being integrally connected with and perpendicular to the first sidewall, a second protrusion of the channel being integrally connected with and perpendicular to the second sidewall, the baseplate configured to mount to a piece of machinery; and
a channel insert component comprising:
an opening through an anterior face of the channel insert component configured to receive one or more elongated objects, the opening defined by one or more radiused edges between the anterior face and a posterior face of the channel insert component, the one or more radiused edges configured to mitigate abrasion of the one or more elongated objects during operation of the machinery or during vibration or other movement of the one or more radiused edges against the one or more elongated objects;
a first notch and a second notch in the channel insert component configured to detachably secure the channel insert component to the channel, the first notch configured to receive the first protrusion and resist movement of the first protrusion out of the first notch, the second notch configured to receive the second protrusion and resist movement of the second protrusion out of the second notch; and
a gap across a lateral face of the channel insert component along the opening, the gap disposed between one or more cantilevers of the lateral face, the one or more cantilevers being flexible from an initial shape to widen the gap and enable the one or more elongated objects to fit through the gap and into or out of the opening, the one or more cantilevers being resilient to return to the initial shape.

16. The channel assembly of claim 15, wherein the first notch is defined by a first anterior ridge and a first posterior ridge, the first anterior ridge spacing the one or more elongated objects apart from an edge of the first protrusion of the channel, and wherein the first posterior ridge includes an angled portion facing the first notch such that the channel insert component can be removed from the channel by pushing the channel insert component towards an outside of the channel from inside of the channel.

17. The channel assembly of claim 15, wherein the channel insert component is composed of a material having a durometer providing mitigation of abrasion of the one or more elongated objects.

18. The channel assembly of claim 15, wherein a width of the one or more radiused edges of the channel insert component is wider than the first protrusion of the channel.

19. The channel assembly of claim 15, wherein the one or more cantilevers of the lateral face have a flat surface facing the opening.

20. The channel assembly of claim 15, further comprising a channel cover plate detachably secured to the first protrusion and the second protrusion, wherein the channel cover plate includes a detent configured to receive the first protrusion of the channel.
